(19) United States
(12) Patent Application Publication
(10) Pub. No.: US 2007/0088903 A1
(43) Pub. Date: Apr. 19, 2007

(54) Memory module, memory system and method for controlling the memory system

(75) Inventor: Joo-Sun Choi, Yongin-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/541,829

(22) Filed: Oct. 2, 2006

(30) Foreign Application Priority Data
Oct. 17, 2005 (KR) 2005-97355

(51) Int. Cl. G06F 12/00

(52) U.S. Cl. 711/100

(57) ABSTRACT

In a memory system and a memory module having a large capacity and operating at high speed, the memory module includes a module board, a primary memory component that is mounted on the module board, accessed as a master, and has a first column access latency, and a secondary memory component that is mounted on the module board, accessed as a slave, and has a second column access latency, which is shorter than the first column access latency. The memory system operates at high speed regardless of a repetition delay in a repeated link configuration in which the memory components are linked as hierarchy.

### CROSS-REFERENCE TO RELATED APPLICATION

This application claims the benefit under 35 U.S.C. §119 to Korean Patent Application No. 2005-97355 filed on Oct. 17, 2005, the contents of which are herein incorporated by reference in their entirety.

### BACKGROUND OF THE INVENTION

1. Technical Field

The present disclosure relates to a memory system and a method of controlling the memory system. More particularly, the present disclosure relates to a memory system in which primary memory devices and secondary memory devices are configured as a repeated link configuration, and a method of controlling the memory system.

2. Discussion of the Related Art

As a central process unit (CPU) of a computer system becomes faster and more highly effective, a synchronous dynamic random access memory (SDRAM) has been required to be faster in speed and larger in capacity. The speed of the SDRAM, however, falls behind that of the CPU so far. In general, the CPU receives and transfers data from/to the SDRAM via a memory controller to buffer the data intermediately.

FIG. 1 is a block diagram illustrating a conventional memory system. Referring to FIG. 1, because a main memory is large in capacity, DRAM components DRAM11˜DRAMmn are arranged in a matrix. In each row, the DRAM components DRAM21˜DRAM2n, - - - , DRAMm1˜DRAMmn share corresponding command/address buses CABUS1, CABUS2, - - - , CABUSm. In each column, the DRAM components DRAM11˜DRAMm1, DRAM12˜DRAMm2, - - - , DRAM1n˜DRAMmn share corresponding data buses DBUS1, DBUS2, - - - , DBUSn. As the number of DRAM components connected in a column direction is increased, capacitive loads of data I/O pins of a memory controller 12 become larger. Similarly, as the number of DRAM components connected in a row direction is increased, capacitive loads of command/address output pins of the memory controller 12 also become larger.

When an operative clock frequency of the DRAM components is relatively low and the capacitive loads of the respective pins are relatively large, signal transfer characteristics of such a multi-drop bus configuration do not have serious problems. When the operative clock frequency of the DRAM components becomes high and the capacitive loads of the pins need to be considered, however, it would be difficult to expand the memory because restraining the capacitive loads limits the number of DRAM components.

In a double data rate 2 (DDR2) DRAM or a double data rate 3 (DDR3) DRAM with the multi-drop bus configuration, it has been difficult to expand a size of the memory without using large capacity DRAM components.

Recently, a point-to-point (P2P) bus configuration has been developed. In the P2P bus configuration, the number of DRAM components directly connected to a memory controller may be limited by a restriction on the pin arrangement of the memory controller.

To expand the capacity of the memory in the P2P bus configuration, a repeated link configuration shown in FIG. 2 needs to be introduced; Referring to FIG. 2, the repeated link configuration is configured as a primary DRAM component 24 that is directly connected to a memory controller 22 and delivers commands, addresses or data to a secondary DRAM component 26. The primary DRAM component 24 is connected to the secondary DRAM component 26 by the P2P bus configuration.

The repeated link configuration causes signal delay by an amount of the repetition delay used to transfer the signal from the primary DRAM component 24 to the secondary DRAM component 26. That is, the repeated link configuration may not utilize full performances of the high-speed DRAM devices.

DRAM manufacturers raise performances of the DRAM devices competitively, and a memory system is still required, which may satisfy powerful performance and easy expansion of memory capacity at the same time.

### SUMMARY OF THE INVENTION

Exemplary embodiments of the present invention provide a memory system and a memory control method incorporated in the memory system, which can satisfy powerful performance and easy expansion of memory capacity at the same time.

An exemplary embodiment of the present invention provides a memory controller capable of controlling memory devices operating with different operation characteristics at the same operation frequency.

An exemplary example embodiment of the present invention provides a memory module on which memory devices with different operation characteristics at the same operation frequency are mounted.

In an exemplary embodiment of the present invention, a memory system includes a memory controller, a primary memory component and a secondary memory component. The primary memory component receives a read command directly from the memory controller via a first bus, repeats the read command, and transmits first read data responding to the read command after a first latency time elapses, directly to the memory controller via a second bus. The secondary memory component receives the repeated read command directly from the primary memory component via a third bus, and transmits a second read data responding to the repeated read command directly to the memory controller via a fourth bus after a second latency time elapses.

In an exemplary embodiment of the present invention, a memory controller includes a recording medium that is physically readable and program codes that are stored in the recording medium and are physically readable. The program codes perform setting up a first latency time for a primary memory component; setting up a second latency time for a secondary memory component; transmitting a combined read command, which includes a first read command for a primary memory component and a second read command for a secondary memory component, directly to the primary memory component; receiving first read data directly from the primary memory component responding to the first read command after a first latency time elapses; and receiving second read data directly from the secondary memory component responding to the second read command transmitted from the primary memory component after a second latency time elapsing.

The memory controller may receive the first read data and the second read data substantially at the same time. A difference between the first latency time and the second latency time may be substantially equal to the number of clock pulses for the repeated read command traveling from the primary memory component to the secondary memory component.

The primary memory component and the secondary memory component respectively operate at the same operation frequency, and the first latency time is longer than the second latency time by an amount of clock pulses for the repeated read command traveling from the primary memory component to the secondary memory component.

In an exemplary embodiment of the present invention, among memory components that operate at an operation frequency, a memory component that operates relatively fast is selected as the secondary memory component, and another memory component that operates relatively slow is selected as the primary memory component. Additionally, the difference between the operation timing of the primary and secondary memory components is configured to be matched to the number of clock pulses for a repetition delay time, such that the memory system may operate the memory components with their maximum operation speeds and utilize full capability of the memory system.

According to exemplary embodiments of the present invention, the primary and secondary memory components may constitute a memory module with a board, on which the primary and secondary memory components are mounted.

In an exemplary embodiment of the present invention, a method of controlling a memory system includes transmitting a combined read command, which includes a first read command for a primary memory component and a second read command for a secondary memory component, directly to the primary memory component; receiving first read data directly from the primary memory component responding to the first read command after a first latency time has elapsed; and receiving second read data directly from the secondary memory component responding to the second read command transmitted from the primary memory component after a second latency time has elapsed.

The first read data and the second read data respectively from the primary memory component and the secondary memory component may be received substantially at the same time. A difference between the first latency time and the second latency time may be substantially equal to the number of clock pulses for the repeated read command traveling from the primary memory component to the secondary memory component. The primary memory component and the secondary memory component respectively operate at the same operation frequency, and the first latency time may be longer than the second latency time by an amount of clock pulses for the repeated read command traveling from the primary memory component to the secondary memory component.

In an exemplary embodiment of the present invention, a memory module includes a primary memory component that receives a read command directly from an exterior via a first bus repeats the read command, and transmits first read data responding to the read command after a first latency time has elapsed directly to the exterior via a second bus. The memory module includes a secondary memory component that receives the repeated read command directly from the primary memory component via a third bus, and transmits a second read data responding to the repeated read command after a second latency time elapsing directly to the exterior via a fourth bus.

The memory controller may receive the first read data and the second read data substantially at the same time. The first latency time may be longer than the second latency time. A difference between the first latency time and the second latency time may be substantially equal to the number of clock pulses for the repeated read command traveling from the primary memory component to the secondary memory component. The first bus and the third bus may transfer command signals as well as write data. The primary memory component and the secondary memory component may respectively operate at the same operation frequency, and the first latency time may be longer than the second latency time by an amount of clock pulses for the repeated read command traveling from the primary memory component to the secondary memory component.

### BRIEF DESCRIPTION OF THE DRAWINGS

Exemplary embodiments of the present invention will be understood in more detail from the following descriptions taken in conjunction with the accompanying drawings, in which:

FIG. 1 illustrates a conventional memory system;

FIG. 2 illustrates a conventional memory system having a typical repeated link configuration;

FIG. 3 is a block diagram illustrating a memory system according to an exemplary embodiment of the present invention;

FIG. 4 is a block diagram illustrating a primary protocol memory element according to an exemplary embodiment of the present invention;

FIG. 5 is a timing diagram illustrating a format of a command and address packet when a downloading bus has six data lines;

FIG. 6 is a truth table of OP fields of the command in FIG. 5;

FIG. 7 is a timing diagram illustrating a format of a write data packet when the downloading bus has six data lines;

FIG. 8 is a timing diagram illustrating a format of a read data packet when an uploading bus has four data lines;

FIG. 9 is an operation timing diagram illustrating a read operation according to an exemplary embodiment of the present invention; and

FIGS. 10 through 13 are timing diagrams respectively illustrating command and address packets according to the read operation in FIG. 9.

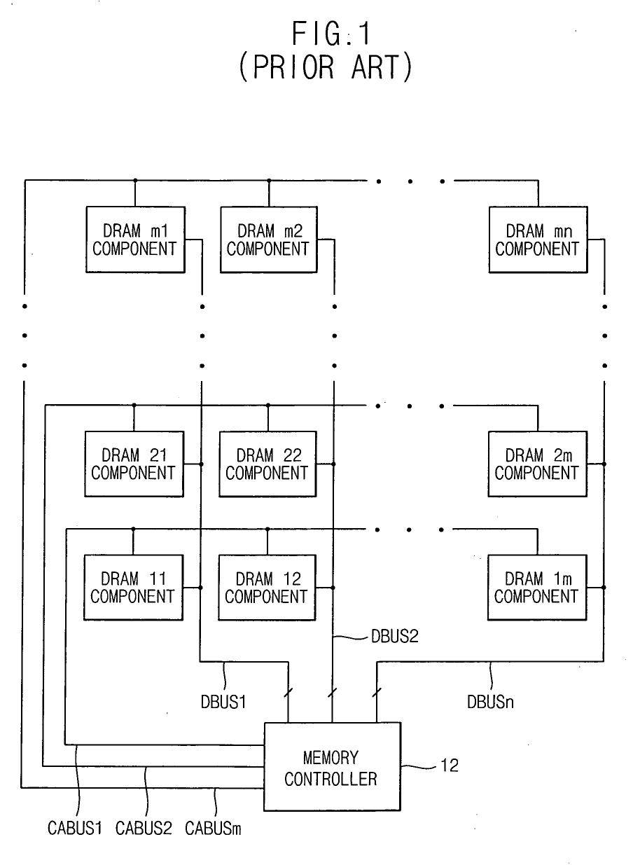

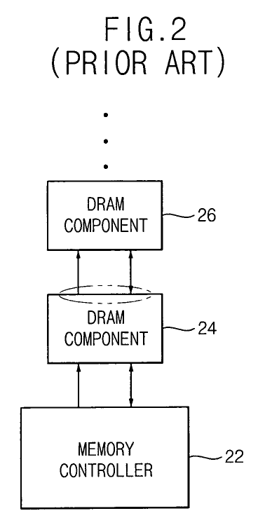

### DESCRIPTION OF EXEMPLARY EMBODIMENTS

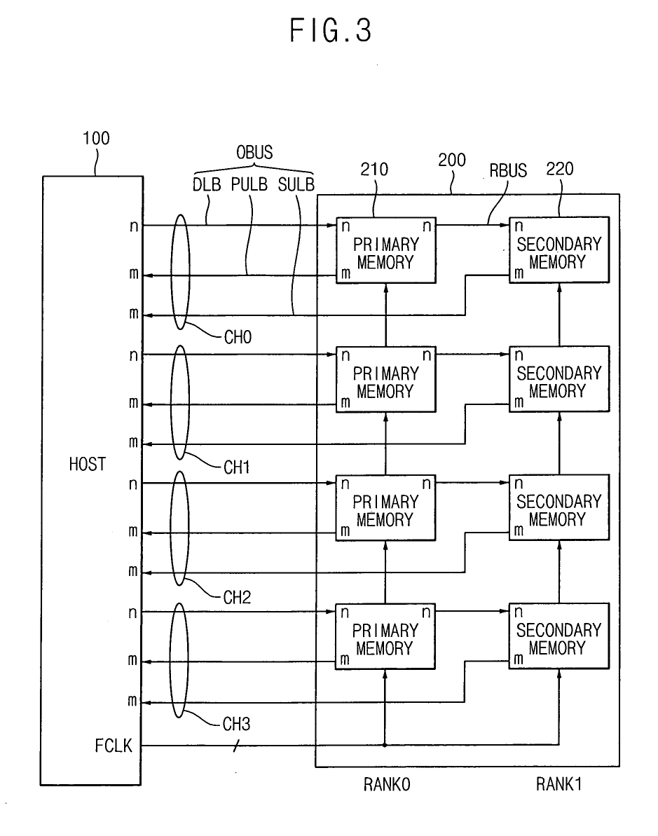

FIG. 3 is a block diagram illustrating a memory system according to an exemplary embodiment of the present invention.

Referring to FIG. 3, the memory system includes a memory controller 100 and a memory module 200. The memory controller 100 is connected to the memory module 200 via four bus channels CH0, CH1, CH2 and CH3. Each of the bus channels is composed of an n-bit downloading bus DLB and two m-bit uploading buses PULB and SULB. The m-bit uploading bus PULB is an uploading bus for a primary memory component and the other m-bit uploading bus SULB is an uploading bus for a secondary memory component. The memory controller 100 provides a plurality of reference clock signals FCLK to the memory module 200. The memory controller 100 contains some physically readable media, for example, read-only memory (ROM), static random access memory (SRAM), flash memory and the like, and program codes to be written and read to/from the media. The memory module 200 includes a primary memory component 210 and a secondary memory component 220, which is repeatedly linked to the primary memory component 210, for every channel. The primary memory 210 is directly coupled to the memory controller 100 via the downloading bus and the uploading buses. The secondary memory 220 is coupled to the memory controller 210 via a repeater bus RBUS. A downloading path is formed from the host, that is, memory controller, 100 to the secondary memory component 220 indirectly via primary memory component 210. An uploading path is formed directly from the secondary memory component 220 to the host 100.

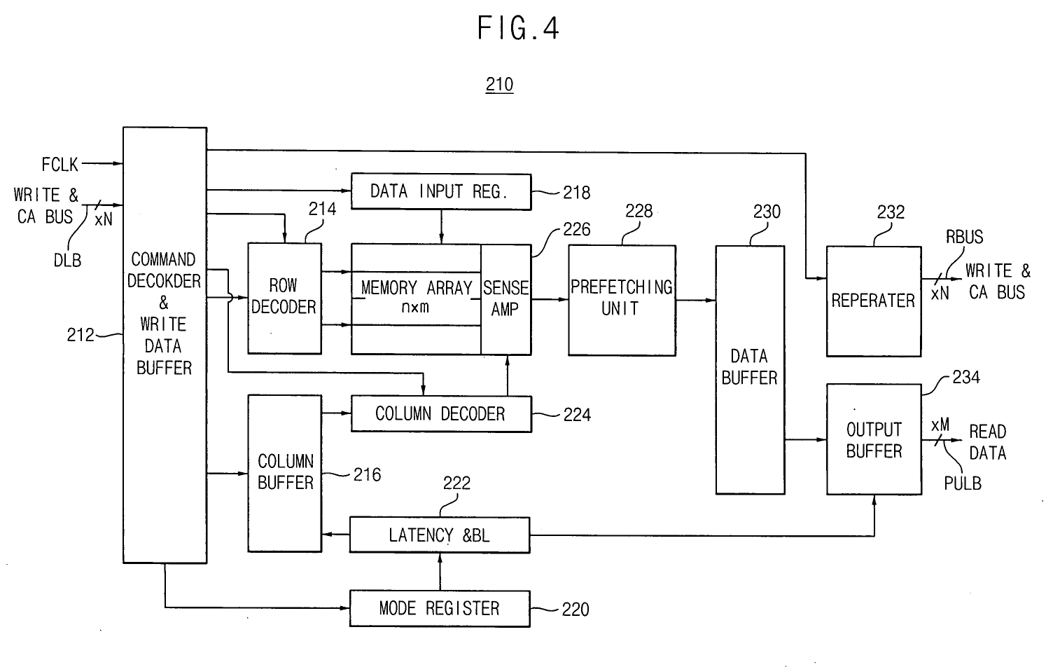

FIG. 4 is a block diagram illustrating a primary protocol memory element according to an exemplary embodiment of the present invention.

Referring to FIG. 4, the primary memory component 210 includes a command decoder and write data buffer block 212, a row decoder 214, a column address buffer 216, a data input register 218, a mode register 220, a latency and burst length control block 222, a column decoder 224, a memory core 226, a pre-fetch block 228, a read data buffer 230, an output buffer 234 and a repeater 232.

The command decoder and write data buffer block 212 is directly coupled to the memory controller 100 via a downloading bus DLB. The downloading bus DLB is used as a downloading path for write data, command signals and address signals. The command decoder and write data buffer block 212 executes a demultiplexing operation with received packets and converts the received packets to parallel data to be processed. The write data among the converted parallel data are provided to the data input register 218. The address signals in the parallel data are provided to the row decoder 214, the column buffer 216, the mode register 220, etc. Additionally, the command decoder and write data buffer block 212 provides the command, address signals, and the write data to the repeater 232. The mode register 220 provides mode set values included in the address signals to the latency and burst length control block 222. In response to the mode set values, the latency and burst length control block 222 generates a latency control signal and a burst length control signal to control the column address buffer 216 and the output buffer 234. Therefore, the primary memory component 210 is set up with a column latency agreeable to a given operation clock speed.

The memory core 226 includes memory cell arrays and sense amplifiers. In a write operation, the write data from the data input register 218 are written at cells in the memory core 226 designated by the row decoder 214 and the column decoder 224. In a read operation, the read data are read from cells in the memory core 226 designated by the row coder 214 and the column decoder 224 and are provided to the output buffer 234 via the pre-fetch block 228 and the read data buffer 230.

The output buffer 234 executes a multiplexing operation with the read data provided from the read data buffer 230 to convert the read data to a read data packet and outputs the read data packet after elapse of the column latency, which is determined by the mode register 220.

The repeater 232 reconstructs the write data or the command and address packets to be provided to the secondary memory component 220 via the repeater bus RBUS. Because of passing through such a repetition path, the command and address packets arrived at the secondary memory component 220 are delayed by given clocks compared with those at the primary memory component 210. The secondary memory component 220 may include circuit elements that operate early by the delayed clocks. The secondary memory component 220 may be set up with a column latency according to the given clock speed, which is different from the column latency of the primary memory component 210.

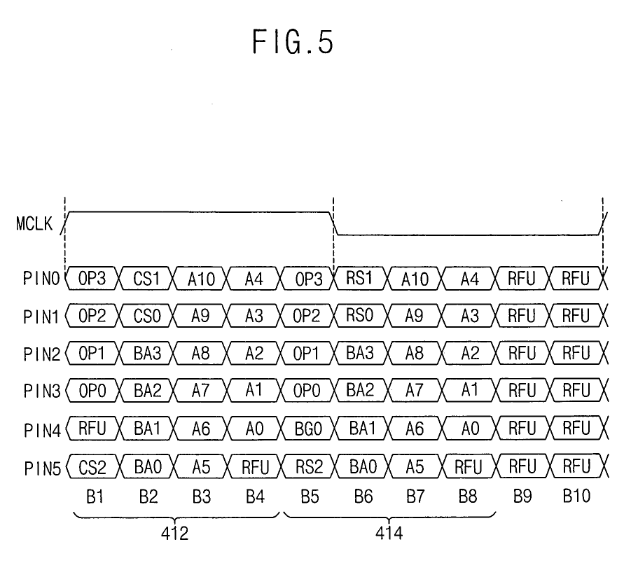

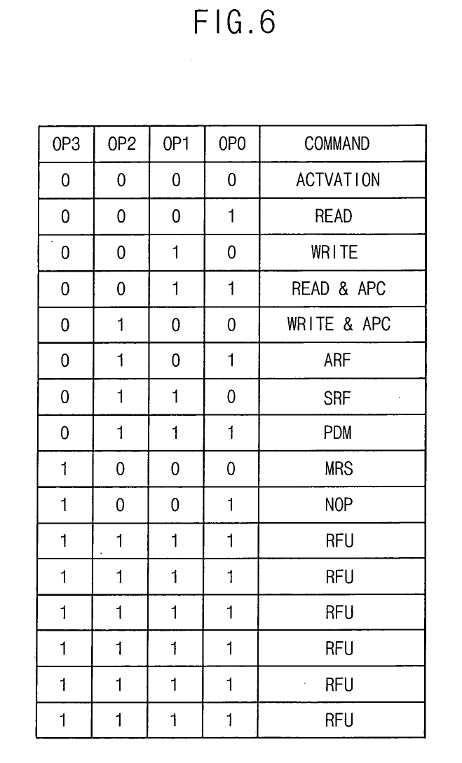

FIG. 5 is a timing diagram illustrating a format of a command and address packet when a downloading bus has six data lines. FIG. 6 is a truth table of OP fields of the command in FIG. 5.

Referring to FIG. 5, the command and address packet include six lines, ten burst lengths every line, that is, 60 bits of data per one clock period of a memory clock signal MCLK. A partial field 412 is a command and address field corresponding to the primary memory component. Another partial field 414 is a command and address field corresponding to the secondary memory component.

One of sixteen operation command codes in FIG. 6 may be assigned to four bits OP0 through OP3 in the partial field 412. Three bits CS0 to CS2 in the partial field 412 are prepared for rank selection codes. Four bits BA0 through BA3 in the partial field 412 are respectively for a bank address to designate one of sixteen banks. Eleven bits A0 to A10 in the partial field 412 are for a row address or a column address.

Three bits RS0 to RS2 of the partial filed 414 corresponding to the command and address of the secondary memory component are for rank selection codes, likewise to the three bits CS0, CS1 and CS2 of the partial field 412.

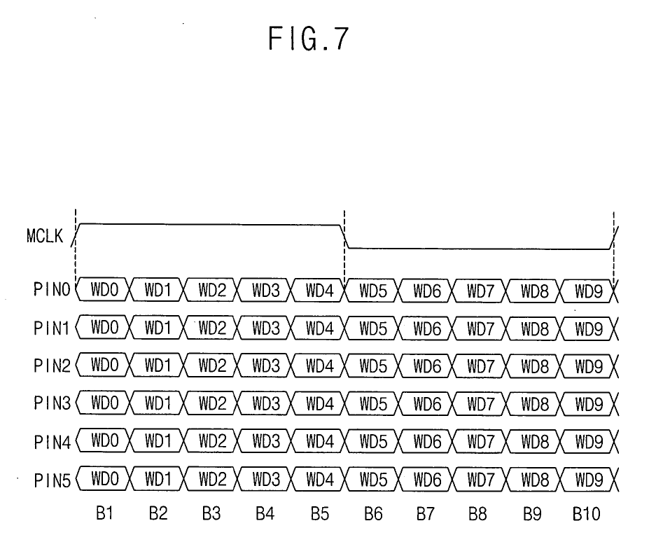

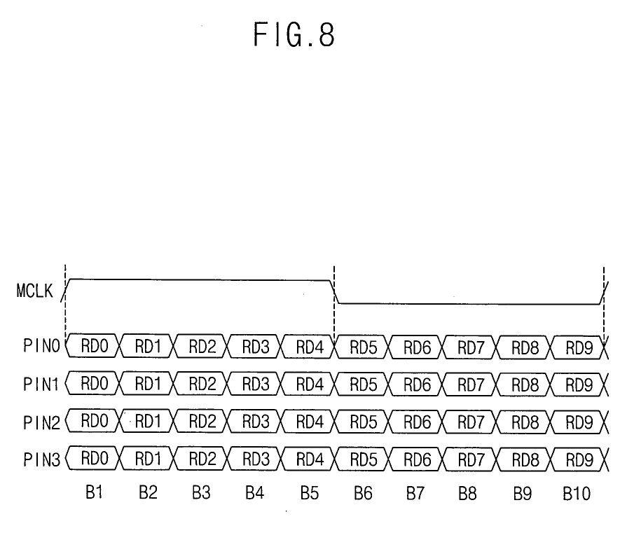

FIG. 7 is a timing diagram illustrating a format of a write data packet when the downloading bus has six data lines. FIG. 8 is a timing diagram illustrating a format of a read data packet when an uploading bus has four data lines.

Referring to FIG. 7, a write data packet has 60 bits of write data composed of six lines, ten burst lengths every line. Referring to FIG. 8, a read data packet has 40 bits of read data composed of four lines, ten burst lengths every line.

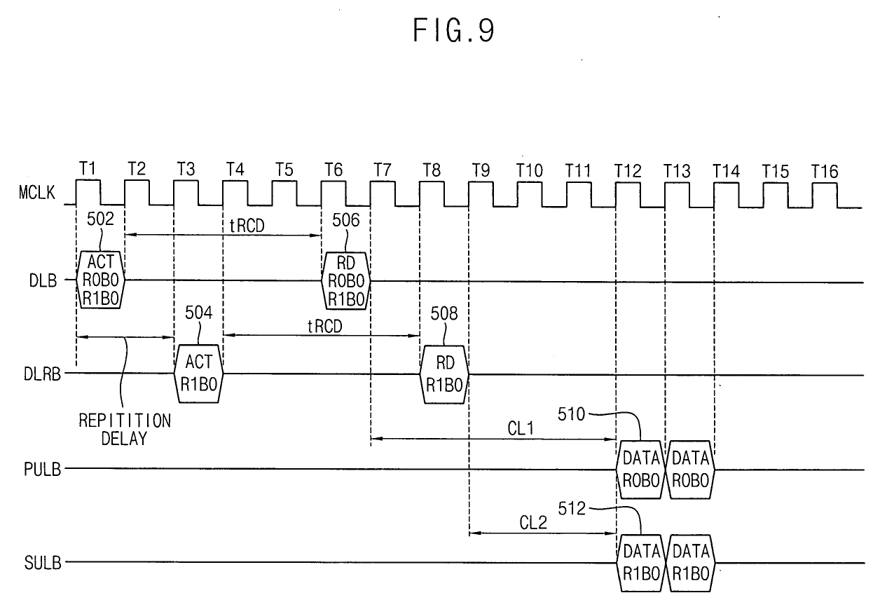

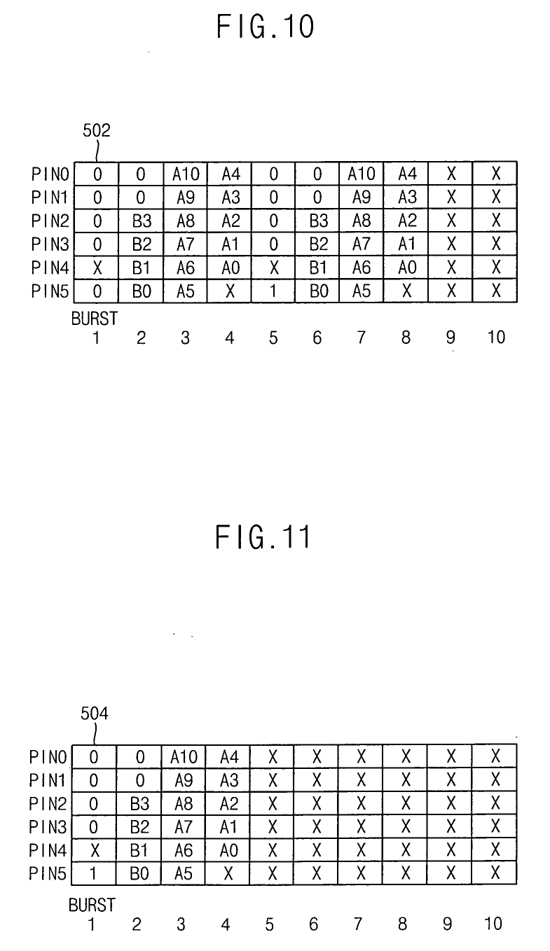

FIG. 9 is an operation timing diagram illustrating a read operation according to an exemplary embodiment of the present invention. FIGS. 10 through 13 are timing diagrams respectively illustrating command and address packets according to the read operation in FIG. 9.

The memory controller 100 sets up a column latency CL1 of the primary memory component 210 as five clocks according to a given operation speed and another column latency CL2 of the secondary memory component 220 as three clocks according to another given operation speed, via the MRS command. The difference between the column latencies CL1 and CL2 is two clocks and this two-clock difference agrees with an interval to transmit signals to the secondary memory component 220 via the primary memory component 210. That is, the memory controller 100 downloads the command and address packet to the memory modules 200 via the downloading bus DLB after setting up the respective column latencies of the memory components according to respectively given operation speeds.

The protocol memory element 210, also referred to as the primary memory component 210, acquires the command and address packet 502 of FIG. 10 from the memory controller 100 via the downloading bus DLB at the front edge of a clock pulse T1 in FIG. 9. Because the 3-bit field CS0 to CS2 of the packet is 000, the protocol memory element 210 executes an ACT command corresponding to 0000 in the 4-bit field OP0 to OP3 of the packet. In response to the ACT command, a row address of the corresponding bank in the primary memory component 210 is activated and cell data are transferred from a plurality of memory cells related to the activated row address to sense amplifiers. Also, the primary memory component 210 repeats the command and address packet 504 for rank1 in FIG. 11 to the secondary memory component 220 via the repeater bus RBUS at a front edge of a clock pulse T3 in FIG. 9. The secondary memory component 220 interprets the command and address packet 504. Because the 3-bit field RS0 to RS2 of the packet is 001, the secondary memory element 220 executes an ACT command corresponding to 0000 in the 4-bit field OP0 to OP3 of the packet. In response to the ACT command, a row address of corresponding bank in the secondary memory component 220 is activated and cell data are transferred from a plurality of memory cells related to the activated row address to sense amplifiers.

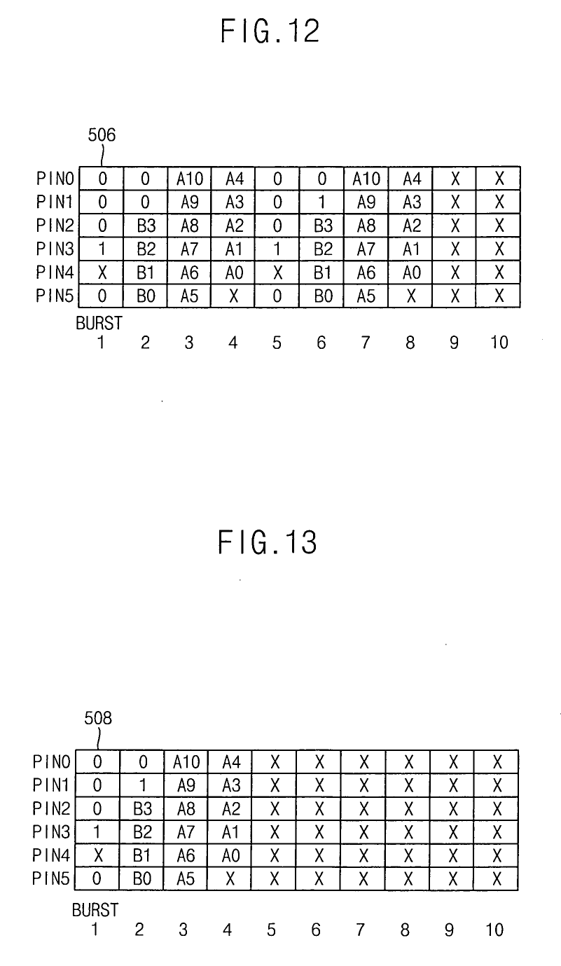

At the front edge of a clock pulse T6 in FIG. 9, the primary memory component 210 acquires the command and address packet 506 of FIG. 12. Because the 3-bit field CS0 to CS2 of the packet is 000, the protocol memory element 210 executes a READ command corresponding to 1000 in the 4-bit field OP0 to OP3 of the packet. In response to the READ command, cell data at the sense amplifiers of the corresponding bank in the primary memory component 210 are transferred from the sense amplifiers to the output buffer 234 via the data buffer 230. The output buffer 234 outputs the read data packet 510 after the first column latency set up by the mode register elapses. That is, the read data packet 510 is transferred from the primary memory component 210 via the uploading bus PULB to the memory controller 100 at a front edge of a clock pulse T12, after the five-clock-long column CAS latency elapses.

At the front edge of a clock pulse T8 in FIG. 9, the secondary memory component 220 acquires the command and address packet 508 of FIG. 13. Because the 3-bit field RS0 to RS2 of the packet is 001, the secondary memory component 220 executes a READ command corresponding to 0001 in the 4-bit field OP0 to OP3 of the packet 508. In response to the READ command, cell data at the sense amplifiers of the corresponding bank in the secondary memory component 220 are transferred from the sense amplifiers to the output buffer via the data buffer. The output buffer outputs the read data packet 512 after the second column latency set up by the mode register elapses. That is, the read data packet 512 is transferred from the secondary memory component 220 via the uploading bus SULB to the memory controller 100 at a front edge of a clock pulse T12, after the three-clock-long column CAS latency elapses.

Therefore, at the front edge of the clock pulse T12, the memory controller 100 simultaneously receives the read data packets 510 and 512, respectively, from the primary memory component 210 and the secondary memory component 220.

According to exemplary embodiments of the present invention, the memory system may operate at high speed regardless of repetition delay time inevitable in the repeated link configuration, using column latency times of the memory components different from each other.

The foregoing is illustrative of exemplary embodiments of the present invention and is not to be construed as limiting thereof. Although a few exemplary embodiments of the present invention have been described with address and command signals and data coded in a packet, those skilled in the art will readily appreciate that many modifications are possible without materially departing from the novel teachings and advantages of this invention. Accordingly, all such modifications are intended to be included within the scope of this invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

What is claimed is:

1. A memory system comprising:
a memory controller;
a primary memory component configured to receive a read command directly from the memory controller via a first bus, repeat the read command, and transmit first read data responding to the read command after a first latency time elapses, directly to the memory controller via a second bus; and
a secondary memory component configured to receive the repeated read command directly from the primary memory component via a third bus, and transmit a second read data responding to the repeated read command after a second latency time elapses, directly to the memory controller via a fourth bus.

2. The memory system of claim 1, wherein the memory controller receives the first read data and the second read data substantially at the same time.

3. The memory system of claim 1, wherein the first latency time is longer than the second latency time.

4. The memory system of claim 1, wherein a difference between the first latency time and the second latency time is substantially equal to the number of clock pulses for the repeated read command traveling from the primary memory component to the secondary memory component.

5. The memory system of claim 1, wherein the first bus and the third bus transfer command signals as well as write data.

6. The memory system of claim 1, wherein the primary memory component and the secondary memory component respectively operate at a same operation frequency, and the first latency time is longer than the second latency time by an amount of clock pulses for the repeated read command traveling from the primary memory component to the secondary memory component.

7. A method of controlling a memory system comprising:
transmitting a combined read command, which includes a first read command for a primary memory component and a second read command for a secondary memory component, directly to the primary memory component;
receiving first read data directly from the primary memory component, responding to the first read command, after a first latency time elapses; and
receiving second read data directly from the secondary memory component, responding to the second read command transmitted from the primary memory component, after a second latency time elapses.

8. The method of claim 7, wherein the first read data and the second read data respectively from the primary memory component and the secondary memory component are received substantially at the same time.

9. The method of claim 7, wherein difference between the first latency time and the second latency time is substantially equal to the number of clock pulses for the repeated read command traveling from the primary memory component to the secondary memory component.

10. The method of claim 7, wherein the primary memory component and the secondary memory component respectively operate at a same operation frequency, and the first latency time is longer than the second latency time by an amount of clock pulses for the repeated read command traveling from the primary memory component to the secondary memory component.

11. A memory controller comprising:
a recording medium to be physically readable; and
program codes stored in the recording medium and physically readable, wherein the program codes perform:
setting up a first latency time for a primary memory component;
setting up a second latency time for a secondary memory component;
transmitting a combined read command, which includes a first read command for the primary memory component and a second read command for the secondary memory component, directly to the primary memory component;
receiving first read data directly from the primary memory component responding to the first read command after the first latency time elapses; and
receiving second read data directly from the secondary memory component responding to the second read command transmitted from the primary memory component after the second latency time elapses.

12. A memory module comprising:
a primary memory component configured to receive a read command directly from an exterior via a first bus, repeat the read command, and transmit first read data responding to the read command after a first latency time elapses directly to the exterior via a second bus; and
a secondary memory component configured to receive the repeated read command directly from the primary memory component via a third bus, and transmit a second read data responding to the repeated read command after a second latency time elapses directly to the exterior via a fourth bus.

13. The memory module of claim 12, wherein the memory controller receives the first read data and the second read data substantially at the same time.

14. The memory module of claim 12, wherein the first latency time is longer than the second latency time.

15. The memory module of claim 12, wherein a difference between the first latency time and the second latency time is substantially equal to the number of clock pulses for the repeated read command traveling from the primary memory component to the secondary memory component.

16. The memory module of claim 12, wherein the first bus and the third bus transfer command signals as well as write data.

17. The memory module of claim 12, wherein the primary memory component and the secondary memory component respectively operate at a same operation frequency, and the first latency time is longer than the second latency time by an amount of clock pulses for the repeated read command traveling from the primary memory component to the secondary memory component.
